(19) United States
(12) Patent Application Publication
(10) Pub. No.: US 2026/0222988 A1
(43) Pub. Date: Jul. 30, 2026

(54) METHOD AND APPARATUS FOR REDUCING LATENCY FOR A DEVICE-TO-DEVICE COMMUNICATION LINK IN A WIRELESS NETWORK

(71) Applicant: Semtech Corporation, Camarillo, CA (US)

(72) Inventors: Gustav Gerald Vos, Tsawwassen (CA); David Patrick Frey, Coquitlam (CA); Zahid Chowdhury, Richmond (CA); Recep Serkan Dost, Coquitlam (CA); Nikhil Karande, Coquitlam (CA)

(21) Appl. No.: 19/146,700

(22) PCT Filed: Jan. 10, 2024
(86) PCT No.: PCT/US2024/011020

§ 371 Date: Jul. 9, 2025

Related U.S. Application Data
(60) Provisional application No. 63/438,368, filed on Jan. 11, 2023.

(51) Int. Cl. H04W 52/02; H04W 76/28

(52) U.S. Cl. CPC H04W 52/0216; H04W 76/28

(57) ABSTRACT

There is provided a method and apparatus for reducing latency for device-to-device communications in a wireless network, for example a cellular mesh (CeMe) network. In accordance with embodiments, there is provided a method for reducing latency for a D2D communication link in the wireless network. The method includes stopping, by a wireless device, data for cellular communications and transitioning, by the wireless device, to a cellular connected mode discontinuous reception (C-DRX) or a cellular idle mode. The method further includes performing, by the wireless device, D2D communication during an off time associated with the cellular C-DRX or the cellular idle mode.

### CROSS-REFERENCE TO RELATED APPLICATIONS

This application claims the benefit and priority of U.S. Provisional Patent Application No. 63/438,368 filed Jan. 11, 2023, titled “Method and Apparatus for Reducing Latency for a Device-to-Device Communication Link in a Wireless Network”. The foregoing application is incorporated by reference herein in its entirety.

### FIELD

The present invention pertains in general to wireless communication and in particular to methods and apparatuses for reducing latency for device-to-device communication in a wireless network.

### BACKGROUND

A self-organizing network (SON) is a network automation technology that is designed to perform automatic configuration, optimization, diagnosis and healing of wireless networks. A SON network may be considered a mesh (e,g., non-cellular or cellular mesh (CeMe)) network where communication between devices is provided using a device-to-device (D2D) communication protocol. A SON generally includes a controller (i.e. SON controller or SONC) that is at least responsible for assigning a device's role as one or more of a gateway (GW), a cellular device (CD), a mesh node (MN) and an end node (EN) within a wireless network. The GW is responsible for collecting data from a number of end nodes/mesh nodes via a device-to-device (D2D) communication protocol and sending the collected data to the application server, for example via a cellular or a non-cellular communication protocol. The GW may also be responsible for receiving data from the application server, for example via a cellular or a non-cellular communication protocol, and transmitting the received data to the end nodes/mesh nodes via a D2D communication protocol. In addition, application data may be transmitted and received directly by a CD/MN/EN via a cellular or a non-cellular communication protocol. The application data generated can be transmitted from an EN/MN/CD to a GW via a D2D communication protocol. The SONC can also be responsible for the assignment of ENs/MNs/CDs to GWs, for example by informing or instructing the ENs/MNs/CDs to connect to a particular GW.

For devices that are capable of operating using both cellular communication protocol and D2D communication protocol, there can be one or more radios associated therewith. However, for cost efficiency a single radio may be desired that can be used for both communication protocols. As such there can be a latency or delay of D2D communications associated when the device is actively communicating using a cellular communication protocol.

Therefore there is a need for a method and apparatus for reducing latency for device-to-device (D2D) communication in a wireless network, that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a method and apparatus for reducing latency for device-to-device (D2D) communication in a wireless network. In accordance with embodiments, there is provided a method for reducing latency for a D2D communication link in a wireless network. The method includes stopping, by a wireless device, cellular communications and transitioning, by the wireless device, to cellular connected mode discontinuous reception (C-DRX) or cellular idle mode. The method further includes performing, by the wireless device, D2D communication during an off time associated with the cellular C-DRX or the cellular idle mode.

In accordance with embodiments, there is provided a method for reducing latency for a secondary communication link in a wireless network. The method includes stopping, by a wireless device, primary communications and transitioning, by the wireless device, to a power saving mode associated with the primary communications. The method further includes performing, by the wireless device, secondary communications during an off time associated with the power saving mode.

In accordance with embodiments, there is provided a method for reducing latency for a D2D communication link in a wireless network. The method includes receiving, by a wireless device, a request to stop cellular communication and transitioning, by the wireless device, to cellular connected mode discontinuous reception (C-DRX). The method further includes performing, by the wireless device, D2D communication during an off time associated with the cellular C-DRX.

In accordance with embodiments, there is provided a method for reducing latency for a D2D communication link in a wireless network. The method includes receiving, by a wireless device, a request to stop cellular communications and transitioning, by the wireless device, to cellular idle mode. The method further includes performing, by the wireless device, D2D communication.

In accordance with embodiments, there is provided an apparatus for reducing latency for a D2D communication link in a wireless network. The apparatus includes a network interface for receiving data from and transmitting data to network devices connected to the wireless network, a processor and machine readable memory storing machine executable instructions. The machine executable instructions, which when executed by the processor configure the apparatus to perform one or more of the methods discussed above or elsewhere herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an example of a wireless network, for example a wireless mesh network, including gateways, end nodes and radio frequency links connecting gateways and end nodes.

FIG. 2 illustrates a method for reducing latency for device-to-device (D2D) communication, in accordance with embodiments.

FIG. 3 illustrates a method for reducing latency for D2D communication, in accordance with embodiments.

FIG. 4 illustrates a method for reducing latency for D2D communication, in accordance with embodiments.

FIG. 5 illustrates a method for reducing latency for a secondary communication link in a wireless network, in accordance with embodiments.

FIG. 6 illustrates wireless devices configured for D2D communication therebetween, in accordance with embodiments.

FIG. 7 is a schematic diagram of an electronic device, according to embodiments.

It will be noted that throughout the appended drawings, like features are identified by like reference numerals.

### DETAILED DESCRIPTION

It will be readily understood that a wireless device as used herein that can be used in a cellular mesh (or a non-cellular mesh) can be envisioned as essentially any wireless device that is capable of device-to-device (D2D) communication, which may include machine-to-machine (M2M) communication. A wireless device can include a cellular mesh (CeMe) device, non-cellular mesh device, user equipment (UEs), internet of things (IoT) device, M2M device, narrow band (NB) IoT device, machine type communication (MTC) device and other wireless device that can be capable of D2D communication as would be readily understood. In addition, some embodiments of the current disclosure include wireless devices that are capable of both D2D communication and cellular communication, wherein the cellular communication can be defined by a plurality of different protocols including 3^{rd} generation (3G), 4^{th} generation (4G), long term evolution (LTE), new radio (NR), 5^{th} generation (5G) or other cellular protocol as would be readily understood. Although some embodiments, examples and figures are discussed or illustrated for communication using cellular protocol and a D2D protocol, the scope of the instant disclosure also cover communication using two other D2D communications protocols like Zigbee, WiSun, Dect 2020, LoRaWAN or other D2D communication protocol, as would also be readily understood by a person skilled in art (for example, using another D2D protocol in place of a cellular protocol).

For cellular mesh (CeMe) devices to be economically practical, it is desired that the radio thereof be shared for both cellular communication and D2D communication, namely shared between the cellular communication protocol and the mesh or D2D communication protocol. However, the instant application can also be beneficial for dual radio devices, as there are several challenges to be considered when using dual radio. A first consideration is that the transmitter on a device would need extra power to operate dual radios simultaneously, which may not be considered to be ideal. A second consideration is that there are specific absorption ratio maximums (for example, a maximum power that can be safely transmitted near humans) that cannot be exceeded. This can be of bigger concern when both radios associated with a device are transmitting at a maximum power simultaneously. A third consideration is due to the use of a dual radio in a device, wherein there can be interference between the two radios of the same device when the dual radio is operating simultaneously, which can be undesired. Thus, when the instant disclosure is applied to dual radio devices, the above considerations are addressed. For example, when a CeMe device is acting as a gateway (GW) the radio associated with a CeMe device can be time multiplexed. In some cases, for example during active cellular transmissions, the radio can be fully utilized by the cellular communication protocol for long periods of time without gaps large enough to support D2D communication. This can be especially true for regular Long Term Evolution (LTE) devices that may include category 1 (Cat 1) devices, category M1 (Cat-M1) devices or reduced capacity (Redcap) user equipment (UE) which are configured for full duplex frequency division duplexing (FDD). Wireless devices operating in this manner typically do not have gaps which may be present in transmission, for example switch subframes, during active transmissions, wherein it is these gaps that may provide for periods of D2D communication. In addition, some D2D communication protocols, for example long range (LoRa) communication protocol or wireless smart utility network (Wi-SUN) communication protocol are unable to utilize the short gaps. These short gaps may include scheduling subframes and switch subframes, which can be available for LTE-M or LTE machine type communication (MTC) and narrow band (NB) Internet of things (IoT) communications and the like.

As such, it has been realised that it is unlikely to be possible to support simultaneously active cellular and active D2D in these cases which will result in large D2D latencies that can be at least equal to the cellular communication active time, which can be of an unknown duration. This unknown duration can be especially long when considering cellular communications relating to for example large downloads or uploads, firmware updates, security patches, images, video and voice.

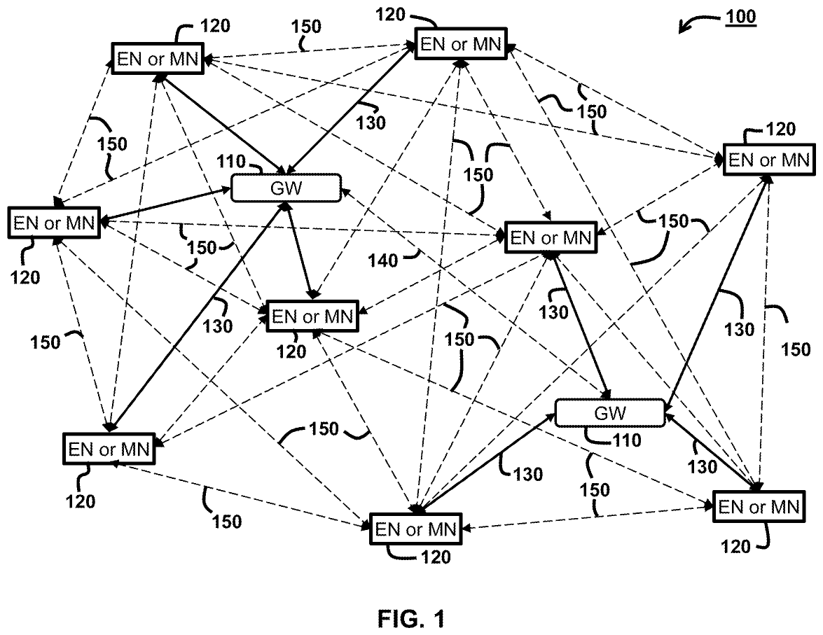

With reference to FIG. 1, this figure illustrates an example of a wireless network (e.g. self-organizing network (SON)) 100 including gateways (GW), end nodes (EN) or mesh nodes (MN) and radio frequency links connecting GWs with ENs or MNs. Referring to FIG. 1, the wireless network 100 includes two GWs 110 and several ENs or MNs 120. Each of the ENs or MNs 120 can be communicatively connected and therefore can be operatively connected to each of the GWs 110. As illustrated in FIG. 1, each EN or MN 120 may be communicatively connected and therefore operatively connected to one of the GWs 110 (e.g. nearby GW) but not (always) communicatively or operatively connected to the other GWs 110, for example due to coverage constraints. The solid lines between the GW 110 and the EN or MN 120 represent EN/MN-to-GW RF links 130, and the dashed lines between the two GWs 110 may represent GW-to-GW RF links 140 and the dashed lines between the two ENs or MNs 120 may represent EN/MN-to-EN/MN RF links 150.

For the instant application, it is assumed that cellular mesh or D2D communications can be supported during connected mode discontinuous reception (C-DRX) Off time. As is understood, C-DRX allows the wireless device operating in cellular communication, for example a UE, to periodically enter ‘sleep’ state, e.g. the Off duration, during which the physical downlink control channel (PDCCH) need not be monitored. In order to monitor the PDCCH for possible downlink or uplink data, during C-DRX the UE is allowed to wake up periodically and to stay ‘awake’, e.g. the On duration, for a certain amount of time before going to ‘sleep’ again. It is understood that normally a long DRX cycle can be greater than, for example, 300 ms, and the time taken to enter C-DRX can be relatively short, for example between 100 ms and 300 ms. It is further understood that these values are merely examples and may vary depending on the cellular service provider.

It is also understood that some D2D protocols can require a longer period of time for D2D communication than that which would be provided by the C-DRX Off time. These D2D protocols can include LoRa wide area network (WAN) which is operating high spreading factors.

However, according to embodiments there is provided a method for forcing the gateway (GW) which is desired for D2D communication, into a cellular Idle mode, namely the wireless device is not active and not engaged in an on-going service, such that the GW radio is free to allow D2D communications for as long as is necessary to perform the D2D transmission. As such, once the D2D transmission is completed, the GW can be configured to reconnect to the cellular communication network.

According to embodiments, the present disclosure provides methods and apparatuses for reducing latency for D2D communication in a wireless network (for example a cellular mesh network (CeMe)).

According to some embodiments where a C-DRX cycle will provide sufficient time for D2D communications, there is provided methods to stop or starve the uplink (UL) and downlink (DL) transmission of cellular data by a wireless device such that the wireless device operating in the cellular protocol naturally enters C-DRX, thereby allowing at least some cellular mesh or D2D transmissions by the wireless device during the C-DRX time cycle.

According to some embodiments, where a C-DRX Off time will provide insufficient time for D2D communications, there is provided a method for forcing the wireless device, for example a gateway (GW) which is desired for D2D communications, into a cellular Idle mode such that the wireless device's radio is free to allow D2D communications for as long as necessary to perform the D2D transmission. Once the D2D transmission is completed, the wireless device can be configured to reconnect to the cellular communication network.

In some embodiments, a wireless device (e.g., GW) that wishes to perform D2D communication with another device must be free of its cellular duties with respect to both UL and DL transmissions and receptions. In some embodiments, when an EN/MN wishes to perform D2D communication, the GW to which it is connected must also be free of its cellular duties, since the data from the EN/MN will pass through the GW. According to some embodiments, there are provided methods for stopping uplink (UL) transmission and/or downlink (DL) transmission of cellular data by a wireless device to be used for D2D communication. The wireless device can include a cellular mesh module (for example a cellular mesh (CeMe) agent) which is operative thereon for at least the provision of one or more actions for stopping UL transmission or DL transmission of cellular data by the wireless device.

According to embodiments, a method for stopping UL data transmission includes the CeMe module or agent operative on the wireless device starve the UL data for UL transmission by actively stopping and buffering outgoing data. As such the CeMe module, upon determination that D2D communication is desired, commences the buffering of the UL data prior to transmission.

According to embodiments, this buffering of the UL data can cause jitter (or transmission delay) in the cellular data stream which can have a similar affect as to when a UE is moving out of cellular coverage. For example, the wireless device can transition to a C-DRX mode, wherein the Off time associated with C-DRX can then provide time gaps for the D2D communication to occur.

In this situation, in order to avoid application user datagram protocol (UDP)/transmission control protocol (TCP) timeouts, according to embodiments it can be desired that the application UDP/TCP layer associated with the wireless device, sets timeouts of a longer length of time than the length of time the data is buffered. In addition, for receiver-driven flow control protocols, such as TCP and other forms of protocols, the CeMe module or agent can proactively set the receive window size to 0 to backoff the sender during this period. In this manner, the wireless device is essentially limiting the ability of a sending device from transmitting data to the wireless device desirous of D2D communication, thereby avoiding interruption to the desired D2D communication. For example, receiver-driven flow control with a window size of 0 causes the sender to quit sending while D2D communication is occurring.

In order to restart cellular data transmission, the CeMe module or agent operative on the wireless device will know when the wireless device has completed the required D2D communications such that the wireless device can subsequently exit C-DRX mode and resume sending the cellular UL data as desired, for example commencing with the UL data that had been buffered in order to initiate a transition to C-DRX mode.

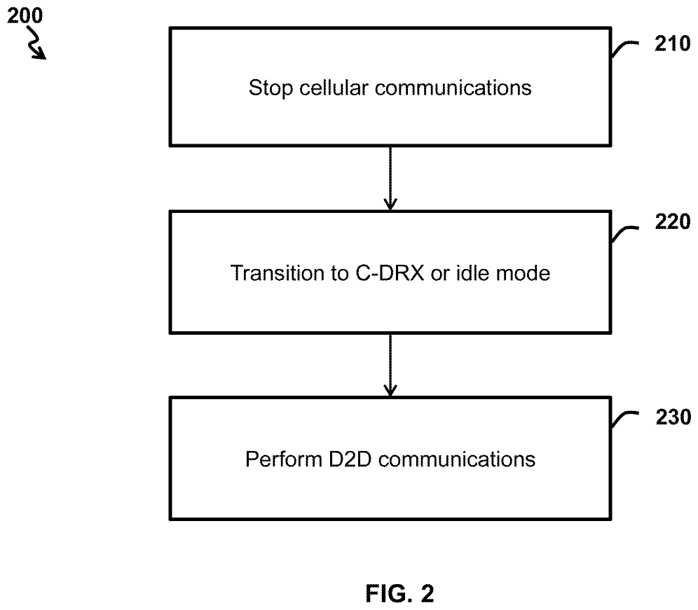

FIG. 2 illustrates, a method 200 for reducing latency for device-to-device (D2D) communication, in accordance with embodiments. The method includes stopping 210, by a wireless device, cellular communications and transitioning 220, by the wireless device, to a cellular connected mode discontinuous reception (C-DRX) or cellular idle mode. The method further includes performing 230, by the wireless device, D2D communication during an Off time associated with the cellular C-DRX or cellular idle mode.

In some embodiments, upon completion of the D2D communication, the method further includes restarting, by the wireless device, cellular communications.

According to embodiments, for stopping DL cellular data transmission it is understood that there are multiple scenarios where DL cellular data transmission to the GW must be stopped in order to allow for D2D communications. A first scenario occurs when the GW wants to send data to an EN/MN via D2D communication and second scenario occurs when the EN/MN wishes to send data to the GW via D2D communication. Each of these scenarios will be discussed further below individually.

According to embodiments a method for stopping DL cellular data transmissions, for example cellular data transmission from the cellular network to the GW, includes upon determination that a GW wants to send data to an EN/MN via D2D communication (i.e., the first scenario identified above), the GW sends a control message in order to request the stopping of DL data transmissions. For example, the message may be termed StopCellularDataReq, however other configurations or formats of the message would be readily understood by a worker skilled in the art. This control message can be sent via a number of different routes or paths. For example, the control message can be sent directly to a user plane function associated with the cellular mesh network, for example a CeMe user plane function (CUPF), or to the CUPF via the SONC (SON controller), or to the packet data network gateway (PGW) directly or to the PGW via the SONC. It is understood that since the PGW may have buffering, stopping the data in the PGW may result in stopping the data in a quicker manner, which may result in a lower latency for the commencement of D2D communication. As such, in some embodiments, integration with MNO (mobile network operator) for providing this type of operation of the PGW associated with the MNO can be desired.

According to embodiments a method for stopping DL cellular data transmissions includes upon determination that an EN/MN wants to send data to a GW (i.e. the second scenario identified above), providing a means for the EN/MN to send data via D2D communication to the GW. It should be noted that, if the EN/MN are capable and configured to perform cellular communications, the EN/MN can also send a control message to the SONC or the CUPF (for example, as discussed above with respect to the first scenario) to request the stopping of the DL cellular communication to the GW. For example, the message may be termed StopCellularDataReq, however other configurations or formats of the message would be readily understood by a worker skilled in the art. This control message can be sent via a number of different routes or paths. For example, the control message can be sent directly to a user plane function associated with the cellular mesh network, for example a CeMe user plane function (CUPF), or to the CUPF via the SONC (SON controller), or to the packet data network gateway (PGW) directly or to the PGW via the SONC.

However, if the EN/MN are not configured to perform cellular communications, then unlike the above discussed first scenario, the EN/MN will not have a direct communication path to one or more of the SONC and the CUPF. In such a situation, in order for the EN/MN to perform D2D communication with the GW, the GW is permitted to at least monitor the D2D reception opportunity (RO) or paging occasion (PO). The GW may be additionally permitted to send D2D beacons. There are three methods for the EN/MN to send data via D2D communication to the GW discussed elsewhere herein in further detail, however it is to be readily understood that these are merely examples and other options to provide a means for the EN/MN to send data via D2D communication to the GW would be readily understood by a worker skilled din the art.

According to embodiments, a first method for the EN/MN to send data via D2D communication to the GW is associated with the SONC. The SONC will have information indicative of the timing of the GW D2D RO and beacons so the SONC can send a control message in order to request the stopping of DL data transmissions. For example, the message may be termed StopCellularDataReq, however other configurations or formats of the message would be readily understood by a worker skilled in the art. This control message can be sent just before the GW D2D RO to either the CUPF or to the PGW directly.

According to embodiments, a second method for the EN/MN to send data via D2D communication to the GW is associated with the GW itself. The GW can send a control message in order to request the stopping of DL data transmissions, for example a StopCellularDataReq, before the GW D2D RO and/or beacons.

According to embodiments, a third method for the EN/MN to send data via D2D communication to the GW is associated with the network. In this method an operational rule can be setup, such that during operation, one or more of the CUPF or PGW always stops DL data transmission during the GW D2D RO and/or beacons. It is understood that by integrating such an operational rule in the operational characteristics of one or more of the CUPF or the PGW can reduce necessary messaging in order to obtain the desired operational characteristics.

According to embodiments, in order to restart cellular downlink data transmission upon completion of the D2D communications, a first option is for the GW/SONC to send a control message for the resumption of DL data transmissions. For example, the message may be termed ResumeCellularDataReq, however other configurations or formats of the request message would be readily understood by a worker skilled in the art.

According to embodiments in order to restart cellular downlink data transmission, a second option is for the GW/SONC to include a desired ‘resume time’ within the StopCellularDataReq. In this manner the GW/SONC are provided with a time frame for the resumption of DL data transmission and as such, the EN/MN has the information required to terminate D2D communication in advance of the expiry of the “resume time”. It is understood that there would be a maximum time to stop or starve the cellular data (which can be in the form of a watch dog timer) in an instance where the control message to StopCellularDataReq is lost or the GW goes offline, thereby preventing permanently stopping or discontinuing of the DL data transmissions.

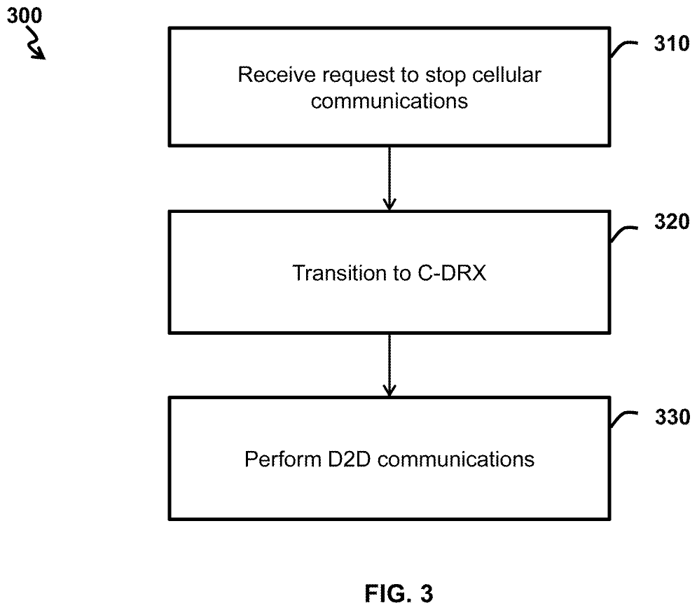

FIG. 3 illustrates, a method 300 for reducing latency for device-to-device (D2D) communication, in accordance with embodiments. The method includes receiving 310, by a wireless device, a request to stop cellular communication and transitioning 320, by the wireless device, to connected mode discontinuous reception (C-DRX). The method further includes performing 330, by the wireless device, D2D communication during an Off time associated with C-DRX. In some embodiments, the method further includes receiving, by the wireless device, a request to resume cellular communications. In some embodiments, the method further includes resuming, by the wireless device, cellular communications after a predetermined time period.

According to embodiments, it is desired that the RO/PO and beacons associated with D2D communications are scheduled such that they do not fall during the cellular On time associated with C-DRX given that during the On time associated with C-DRX the radio associated with the wireless device is required performing actions associated with the cellular protocol at that time. According to embodiments, two options are provided in order to achieve this functionality, however it is to be readily understood that these are merely examples and other options to achieve the desired result of avoiding cellular On time associated with C.DRX would be readily understood by a worker skilled din the art.

According to embodiments, as a first option for ensuring that the RO/PO and beacons associated with D2D communications are scheduled such that they do not fall during the cellular On time associated with C-DRX, the GW receives new C-DRX parameters each time the GW establishes an RRC connection, which is performed for each data transmission. However, it can be understood that for most of the time these new C-DRX parameters can be similar. For example, the “ON” period and the “OFF” period of a C-DRX cycle do not depend on when the data is stop, and as such these periods are predictable in advance and fixed relative to the specific cellular system or network time.

For example, the following equation is suitable at the C-DRX starting on time subframe (SF).

$$[ ( SFN * 10 ) + subframe number ] modulo ( longDRX - Cycle ) = drxStartOffset$$

where the period is the longDRX-Cycle; and
where the SF offset is drxStartOffset.

Having regard to the above, typically the longDRX-cycle is consistent however the drxStartOffset may change with each RRC connection and can also be dependent on the specific wireless device, for example UE. In some embodiments, the GW can send a request (e.g., a control message such as a In Device Co-existence Indication) to the cellular network to request specific C-DRX parameters (e.g., one or more of drxStartOffset, longDRX-Cycle, C-DRX ON time etc.) and/or to request a specific subframe pattern list to identify which subframes can only be used for cellular communication.

According to embodiments, given the above, when the CeMe module or agent operative on the wireless device (e.g., a GW) receives the cellular C-DRX parameters, the GW or the SONC can calculate and assign the D2D communication RO/PO periods and beacon periods in order to ensure these periods do not conflict or fall during C-DRX ON periods. If the network uses different C-DRX settings in the RRC setup and the RRC reconfiguration, the GW will use the settings from the RRC reconfiguration to calculate D2D communication RO/PO and beacon times associated with the GW. The RO/PO and beacon timing information can be sent as part of the beacon so the EN/MN has this information.

According to embodiments, if the C-DRX parameters have changed from the previous RRC connection, the GW can send an updated beacon with updated PO and beacon timing information in the next C-DRX sleep interval. However, if an EN/MN misses a beacon (for example associated with the pre-updated PO and beacon timing), the EN/MN will need to continuously listen for the updated beacon with the new PO and beacon timing information.

According to embodiments, as a second option for ensuring that the RO/PO and beacons associated with D2D communications are scheduled such that they do not fall during the cellular On time associated with C-DRX, is to have 2 GW D2D communication POs or beacons which are separated by a time period at least equal to the C-DRX “ON time”. In this configuration, both D2D communication RO/POs would not overlap with the C-DRX on time. It is understood that the GW would only use one of the two GW D2D communication POs or beacons with a preference being the use of the earlier of the provided GW D2D communication PO or beacons. However, if the EN/MN misses the beacon, the EN/MN would have to try and decode the beacon and the second latter location, which has a disadvantage of additional power consumption.

According to some embodiments, there are provided methods for forcing the GW into cellular Idle mode such that the radio is free to allow D2D communications for as long is required to perform the D2D transmission. When the D2D communication is complete, the GW can re-connect to cellular network. For this embodiment, the UL and DL data will also need to be stopped, by a method discussed elsewhere herein, in order to allow the GW to transition to cellular Idle mode.

For this embodiment, after the UL and DL data has been stopped, the GW waits for the base transceiver station (BTS), for example an eNB, gNodeB, gNB or the like, to release the wireless device, for example a UE, and allow the wireless device to transition to cellular Idle mode. In some embodiments, the GW can use the release assistance information (RAI) feature associated therewith in order to shorten the time to transition to cellular idle mode. In some embodiments, a known method to reduce radio resource control (RRC) connection overhead can also be used, examples of which can be non-internet protocol data delivery (NIDD), control plane optimization, suspend/resume mechanisms and pre-configured UL resources (PUR).

It is understood that in some cases D2D data transmissions from a GW to an EN/MN are typically not deterministic and may be as long at the longest active session, which may be several seconds. However, for firmware downloads, these data transmissions may be several minutes. According to embodiments, the latency for D2D data from a GW to an EN may be considered to be at least partially defined by the summation of the time to send a StopCellularDataReq Msg to SONC (about 20 ms), the time to clear DL buffers of the radio access node (RAN) (about 50 ms), C-DRX inactivity time period (about 300 ms). As such the latency the latency for D2D data from a GW to an EN can be approximately 370 ms (i.e. 20+50+300).

It is understood that in some cases D2D data transmissions from an EN to a GW are not deterministic since D2D communication PO of the GW may be missed several times by the EN and thus may be considered to be unbounded. According to embodiments, the latency for D2D data transmissions from an EN to a GW can be considered to be essentially zero because the D2D transmission RO/PO will typically not be missed.

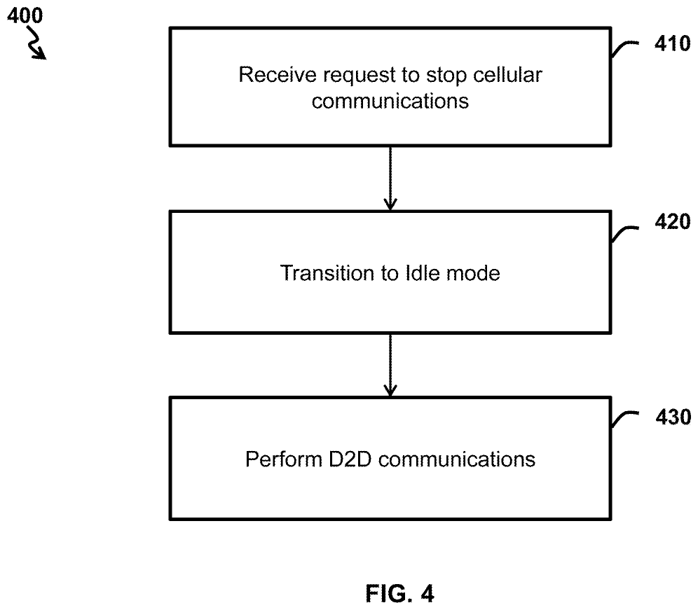

FIG. 4 illustrates, a method 400 for reducing latency for device-to-device (D2D) communication, in accordance with embodiments. The method includes receiving 410, by a wireless device, a request to stop cellular communications and transitioning 420, by the wireless device, to cellular idle mode. The method further includes performing 430, by the wireless device, D2D communication. In some embodiments, prior to performing D2D communication, the wireless device is released by a base transceiver station.

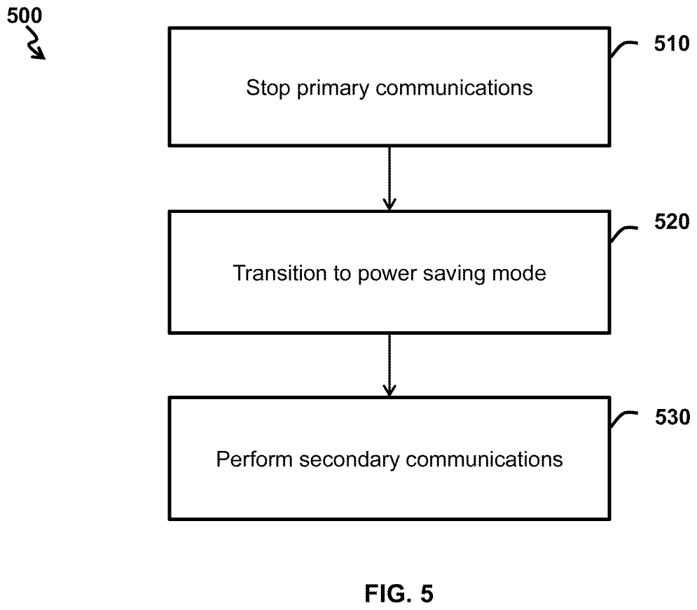

FIG. 5 illustrates a method 500 for reducing latency for a secondary communication link in a wireless network, in accordance with embodiments. The method includes stopping 510, by a wireless device, primary communications and transitioning 520, by the wireless device, to a power saving mode associated with the primary communications. The method further includes performing 530, by the wireless device, secondary communications during an off time associated with the power saving mode. In some embodiments, the primary communications are cellular communications and the secondary communications are device to device (D2D) communications. As such, this method can be generalized as being directed towards the stopping of a first communication session in order to enable a second communication sessions to commence.

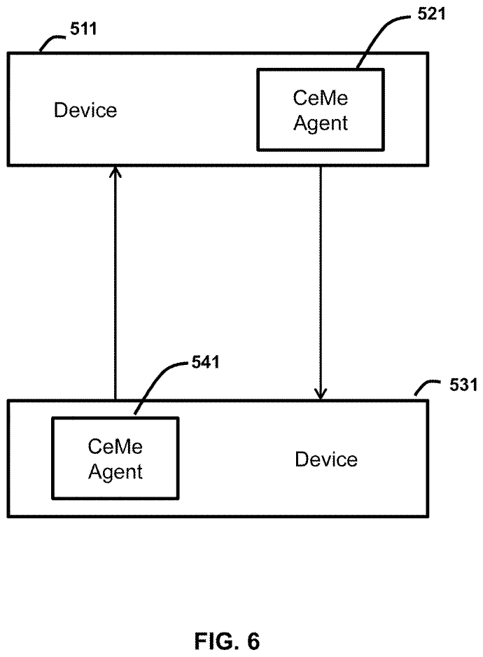

FIG. 6 illustrates wireless devices configured for D2D communication therebetween, in accordance with embodiments. The wireless devices 511, 531 have operative thereon a cellular mesh module or CeMe agent 521, 541. The respective CeMe agent 521, 541 is configured to perform or instruct the wireless device to perform one or more actions as discussed elsewhere herein. These one or more actions provide a means for the wireless device 511, 531 to take one or more necessary actions for the transition back and forth between cellular communications and D2D communications.

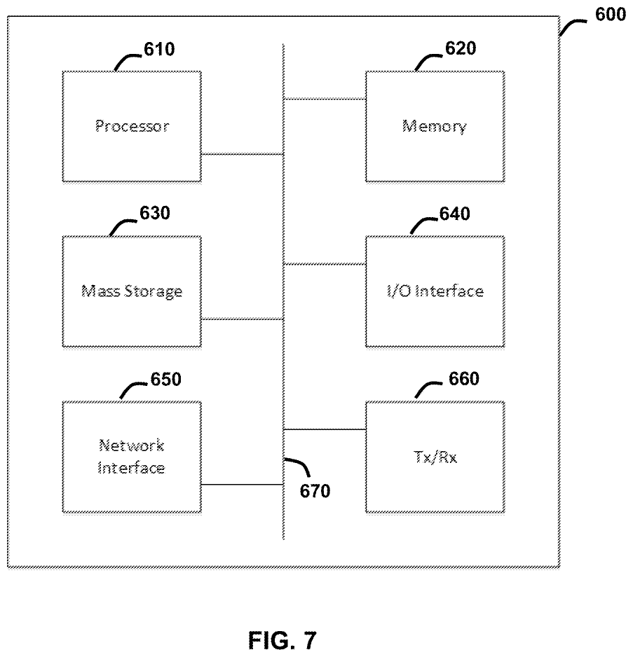

FIG. 7 is a schematic diagram of an electronic device 600 that may perform any or all of the steps of the above methods and features described herein, according to different embodiments. For example, network devices, network nodes, end nodes, computer devices, wireless gateways, mobility routers, access point devices, controller devices, wireless network controllers, SON controllers can be configured as the electronic device. End-user computers, smartphones, IoT devices, etc. can be also configured as electronic devices.

As shown, the device includes a processor 610, memory 620, non-transitory mass storage 630, I/O interface 640, network interface 650, and a transceiver 660, all of which are communicatively coupled via bi-directional bus 670. According to certain embodiments, any or all of the depicted elements may be utilized, or only a subset of the elements. Further, the device 600 may contain multiple instances of certain elements, such as multiple processors, memories, or transceivers. Also, elements of the hardware device may be directly coupled to other elements without the bi-directional bus.

The memory 620 may include any type of non-transitory memory such as static random access memory (SRAM), dynamic random access memory (DRAM), synchronous DRAM (SDRAM), read-only memory (ROM), any combination of such, or the like. The mass storage element 630 may include any type of non-transitory storage device, such as a solid state drive, hard disk drive, a magnetic disk drive, an optical disk drive, USB drive, or any computer program product configured to store data and machine executable program code. According to certain embodiments, the memory 620 or mass storage 630 may have recorded thereon statements and instructions executable by the processor 610 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it Is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1-20. (canceled)

21. A method for reducing latency for a secondary communication link in a wireless network, the method comprising:
stopping, by a wireless device, primary communication;
transitioning, by the wireless device, to a connected mode discontinuous reception (C-DRX) or to an idle mode or to a power saving mode; and
performing, by the wireless device, secondary communication during an off time associated with the C-DRX or the idle mode or the power saving mode.

22. The method of claim 21, wherein stopping primary communication includes stopping one or more of an uplink cellular communication and a downlink cellular communication.

23. The method of claim 22, wherein stopping the uplink cellular communication includes buffering uplink cellular data.

24. The method of claim 22, wherein stopping the downlink cellular communication includes transmission of a control plane message.

25. The method of claim 21, wherein the wireless device is a gateway.

26. The method of claim 21, wherein upon completion of the secondary communication, the method further comprising restarting, by the wireless device, primary communication.

27. The method of claim 21, wherein the primary communication is cellular communication and the secondary communication is device to device (D2D) communication.

28. A method for reducing latency for a secondary communication link in a wireless network, the method comprising:
receiving, by a wireless device, a request to stop primary communication;
transitioning, by the wireless device, to a connected mode discontinuous reception (C-DRX) or to an idle mode; and
performing, by the wireless device, secondary communication during an off time associated with the C-DRX or during the idle mode.

29. The method of claim 28, further comprising receiving, by the wireless device, a request to resume primary communication.

30. The method of claim 28, further comprising resuming, by the wireless device, primary communication after a predetermined time period.

31. The method of claim 28 wherein prior to performing secondary communication, the wireless device is released by a base transceiver station.

32. The method of claim 28, wherein the primary communication is cellular communication and the secondary communication is device to device (D2D) communication.

33. An apparatus for reducing latency for a secondary communication link in wireless network, the apparatus comprising:
a network interface for receiving data from and transmitting data to network devices connected to the wireless network;
a processor; and
machine readable memory storing machine executable instructions which when executed by the processor configure the apparatus to:
buffer data for primary communication;
transition to a connected mode discontinuous reception (C-DRX) or an idle mode; and
perform secondary communication during an off time associated with the C-DRX or the idle mode.

34. The apparatus of claim 33, wherein upon completion of the secondary communication, the machine executable instructions when executed by the processor further configure the apparatus to restart primary communication.

35. The apparatus of claim 33, wherein the apparatus is a gateway.

36. The apparatus of claim 33, wherein the primary communication is cellular communication and the secondary communication is device to device (D2D) communication.

37. An apparatus for reducing latency for a secondary communication link in wireless network, the apparatus comprising:
a network interface for receiving data from and transmitting data to network devices connected to the wireless network;
a processor; and
machine readable memory storing machine executable instructions which when executed by the processor configure the apparatus to:
receive a request to stop primary communication;
transition to a connected mode discontinuous reception (C-DRX) or an idle mode; and
perform secondary communication during an off time associated with the cellular C-DRX or during the idle mode.

38. The apparatus of claim 37, wherein the machine executable instructions when executed by the processor configure the apparatus to receive a request to resume primary communication.

39. The apparatus of claim 37, wherein the machine executable instructions when executed by the processor configure the apparatus to resume primary communication after a predetermined time period.

40. The apparatus of claim 37, wherein the primary communication is cellular communication and the secondary communication is device to device (D2D) communication.
